(19) United States
(12) Patent Application Publication
(10) Pub. No.: US 2004/0234716 A1
(43) Pub. Date: Nov. 25, 2004

(54) Method for forming endless belt

(76) Inventors: Michael D. Madden, Winchester, VA (US); Matthew T. Vosika, Middletown, VA (US)

Correspondence Address: MYERS BIGEL SIBLEY & SAJOVEC, PO BOX 37428, RALEIGH, NC, 27627, US

(21) Appl. No.: 10/441,513

(22) Filed: May 21, 2003

(51) Int. Cl. B32B 25/02; D21F 3/00

(52) U.S. Cl. 428/37; 442/37; 442/399; 162/358.4; 162/901; 264/103

(57) ABSTRACT

A process for forming a belt for a press, such as a shoe press belt, includes the steps of: providing an elongate cylindrical core having a longitudinal axis; rotating the core about the longitudinal axis; providing a nozzle movable along a nozzle path that is substantially parallel to and above the core longitudinal axis, the nozzle having at least an upstream outlet and a downstream outlet, the nozzle outlets being longitudinally offset a distance from each other; and applying multiple strips of polymeric material to the core through the nozzle outlets as the nozzle moves along the nozzle path such that the downstream strip forms an overlapping spiral inner layer and the upstream strip forms an overlapping spiral outer layer that overlies the inner layer.

### FIELD OF THE INVENTION

The present invention relates generally to belts for industrial presses, and more particularly to methods of forming belts for industrial presses.

### BACKGROUND OF THE INVENTION

In a typical papermaking process, a water slurry, or suspension, of cellulosic fibers (known as the paper “stock”) is fed onto the top of the upper run of an endless belt of woven wire and/or synthetic material that travels between two or more rolls. The belt, often referred to as a “forming fabric,” provides a papermaking surface on the upper surface of its upper run which operates as a filter to separate the cellulosic fibers of the paper stock from the aqueous medium, thereby forming a wet paper web. The aqueous medium drains through mesh openings of the forming fabric, known as drainage holes, by gravity or vacuum located on the lower surface of the upper run (i.e., the “machine side”) of the fabric.

After leaving the forming section, the paper web is transferred to a press section of the paper machine, where it is passed through the nips of one or more presses (often roller presses) covered with another fabric, typically referred to as a “press felt.” Pressure from the presses removes additional moisture from the web; the moisture removal is often enhanced by the presence of a “batt” layer of the press felt. The paper is then transferred to a dryer section for further moisture removal. After drying, the paper is ready for secondary processing and packaging.

Over the last 25 or 30 years, a “shoe press” has been developed for the press section of the papermaking machine. A shoe press includes a roll or similar structure that mates with a “shoe” of an opposed roll or press structure; the surface of the shoe is somewhat concave and approximates in curvature the convex profile of the mating roll. This arrangement can increase the width of the nip in the direction of paper travel, thereby enabling greater amounts of water to be removed therein.

Endless belts or blankets have traditionally been used in shoe press operations. The belt overlies and contacts the shoe of the press; in turn, a press felt such as that described above overlies the shoe press belt, and the paper web overlies the press felt. The shoe press belt and press felt travel through the nip and, in doing so, convey the paper web through the nip. The press felt is driven by a set of drive rollers arranged around the shoe or by the press roll itself. In older embodiments, shoe press belts were also driven by sets of drive rollers arranged around the shoe. In some newer configurations, however, the shoe press belt is clamped or otherwise fixed to the edges of circular head plates located on either end of the shoe, such that rotation of the head plates causes the shoe press belt to rotate and travel through the nip.

Given the performance requirements, a shoe press belt should be sufficiently flexible to pass around the drive rollers or head plates and through the shoe and sufficiently durable to withstand the repeated application of pressure within the nip. Because of these performance parameters, most endless belts are formed entirely or predominantly of a polymeric material (often polyurethane). Many shoe press belts also include reinforcing fibers or a reinforcing fabric between or embedded in polymeric layers. Also, shoe press belts may be configured to encourage water to pass from the paper web. To this end, some shoe press belts have grooves or blind-drilled holes in the surface adjacent the press felt that serve to vent water from the paper that is exiting the press felt.

Many belts are formed in a rotational casting operation. In a typical rotational casting process (exemplified in FIGS. 1 and 2), a metallic mandrel or core 10 is positioned horizontally in a rotating fixture that supports the core 10 at one or both ends. A casting nozzle 12 is mounted, either directly to the rotating fixture or separately (for example, on a moving cart or carriage), so that it can move along the longitudinal axis of the roll.

As the casting process commences, the nozzle 12 is positioned above one end of the core 10. The nozzle 12 is continuously supplied with molten polymer 14. As the fixture rotates the core 10 about its longitudinal axis, the nozzle 12 applies a strip 16 of polymeric material to the core 10. As the core 10 rotates, the nozzle 12 translates slowly along the longitudinal axis of the core 10. Typically, the rotational speed of the core 10 and the translation rate of the nozzle 12 are such that, as the core 10 rotates past a specific circumferential location, the nozzle 12 has moved longitudinally a distance that is less than the width of the polymeric strip 16 it is applying. Consequently, each portion of a strip 16 being applied overlies portions of the strips 16a that are applied immediately preceding its application and underlies portions of strips 16b that are applied immediately after its application (see FIG. 2). Because the strips 16 are still molten as they contact each other, bonding can occur between the strips 16 to improve the integrity of the belt. Typically, a portion of a strip 16 will partially overlie portions of between two and seven other strips depending on the material being applied and its thickness.

The afore-described process is equally applicable for belts that have multiple layers of polymeric material. In other words, the typical casting process may involve the application of a base (i.e., radially internal) layer of a belt as it is formed over a mandrel, and/or the application of an outer layer that radially overlies the base layer of the belt. Such a process is particularly applicable when a reinforcing fabric or fiber network is included in the belt, as the application of the outer layer may follow the application of the reinforcement over the base layer.

Although the process described above may be adequate for the formation of many belts, it does have at least one potential shortcoming for thick belts. The polymeric material applied to the core is molten, and is, therefore, somewhat malleable under load (even just the weight of subsequent overlapping layers of polymeric material) until it cools and hardens. The rate of cooling for a strip of polymeric material is typically highly dependent on the thickness of the material. As such, when a relatively thick strip of polymeric material is applied to a core, its weight can cause the polymeric strips that were just applied (i.e., those that it partially overlies) to sag under the load. This tendency is exacerbated by the thickness of the underlying polymeric material, which can cause the underlying material to harden more slowly than a thinner strip would. As a result, there tends to be a practical thickness limit for the casting of some materials.

One approach to forming thicker belts is to maintain a viable thickness in the strips but to increase the extent of the overlap between adjacent layers. In this manner, the underlying layers can harden quickly, but the ultimate thickness of the entire belt is greater. However, this approach results in a substantial increase in casting time.

The foregoing demonstrates that different approaches to the formation of shoe press belts are still needed.

### SUMMARY OF THE INVENTION

The present invention can provide, as a first aspect, a process for forming a belt for a press, such as a shoe press belt. The process includes the steps of: providing an elongate cylindrical core having a longitudinal axis; rotating the core about the longitudinal axis; providing a nozzle movable along a nozzle path that is substantially parallel to and above the core longitudinal axis, the nozzle having at least an upstream outlet and a downstream outlet, the nozzle outlets being longitudinally offset a distance from each other; and applying multiple strips of polymeric material to the core through the nozzle outlets as the nozzle moves along the nozzle path such that the downstream strip forms an overlapping spiral inner layer and the upstream strip forms an overlapping spiral outer layer that overlies the inner layer. This process can produce a belt, such as a shoe press belt or calender belt, that can be formed in greater thickness than has been previously achievable, as the polymeric material underlying that being applied can be sufficiently hardened to resist sagging.

In some embodiments, the core comprises a mandrel and a layer of polymeric material that bonds with the inner layer and is removable from the mandrel as part of the belt; this layer of polymeric material can serve as the base layer of the belt, and may even contain reinforcing fibers (typically axially-extending reinforcing fibers). In other embodiments, circumferential fibers are applied over a portion of the downstream strip prior to the application of the upstream strip over the same axial location.

As a second aspect, the present invention is directed to a process for forming a belt for a press comprising the steps of: providing an elongate cylindrical core having a longitudinal axis; rotating the core about the longitudinal axis; applying a downstream strip of a polymeric material to the core such that the downstream strip forms an overlapping spiral inner layer; then applying an upstream strip of the polymeric material over the inner layer such that the upstream strip forms an overlapping spiral outer layer that overlies the inner layer. The upstream strip should be applied sufficiently proximate in time to the application of the downstream strip that the downstream strip is molten and bondable to the upstream strip, but sufficiently distant in time that the downstream strip has sufficiently hardened to avoid substantial sagging. The axial and/or circumferential reinforcing fibers discussed above may also be applied to the belt in this process, particularly when the core comprises a mandrel and polymeric base layer as described above.

As a third aspect, the present invention is directed to an endless belt for use in a shoe press, comprising: a substantially cylindrical inner layer, the inner layer being formed of a spirally wound, overlapping strip of a first polymeric material; and a substantially cylindrical outer layer that circumferentially overlies the inner layer, the outer layer being formed of a spirally wound, overlapping strip of the first polymeric material. As noted above, such a belt can be formed in a thickness that heretofore may have been unachievable.

In certain embodiments, the belt also includes a polymeric base layer, and circumferential reinforcing fibers are present in the inner layer. Typically, such a belt is formed of a polymeric material selected from the group consisting of: natural rubber; SBR; nitrile rubber, chlorosulfonated polyethylene; EDPM; and polyurethane, with polyurethane being preferred.

### BRIEF DESCRIPTION OF THE FIGURES

FIG. 1 is a partial perspective view of a prior art casting process with a single outlet nozzle.

FIG. 2 is an enlarged partial section view of the core, belt and casting nozzle of FIG. 1 taken along lines 2-2 thereof.

FIG. 3 is a partial perspective view of a casting system with a multiple-outlet casting nozzle for carrying out one embodiment of a process of the present invention.

FIG. 4 is an enlarged partial section view of the core, belt and casting nozzle of FIG. 3 taken along lines 4-4 thereof.

FIG. 5 is a perspective view of an alternative casting system for carrying out another embodiment of a process of the present invention.

FIG. 5A is a greatly enlarged section view of the core, belt and casting nozzle of FIG. 5 taken along lines 5A-5A.

FIG. 5B is an end view of the core, belt and casting nozzle of FIG. 5 illustrating the application of circumferential reinforcing fiber.

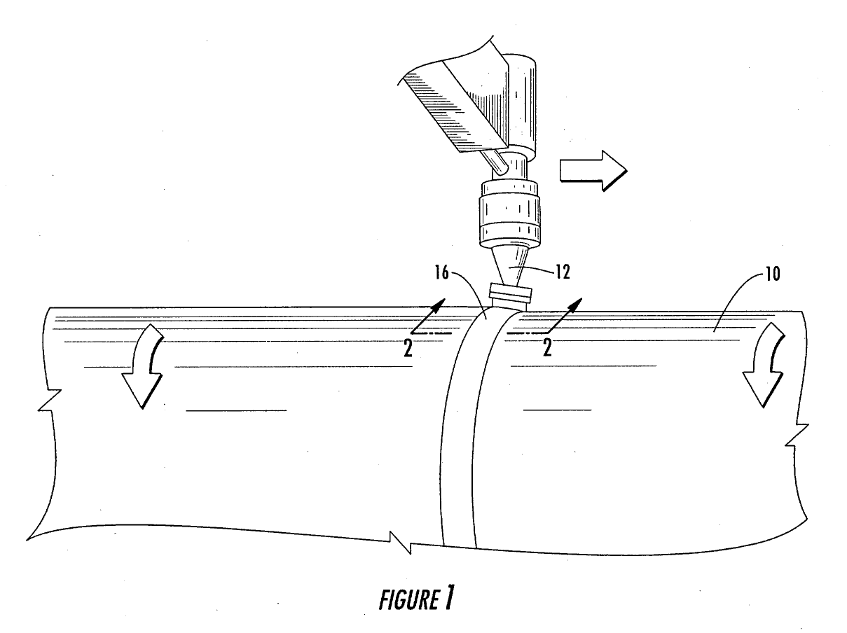

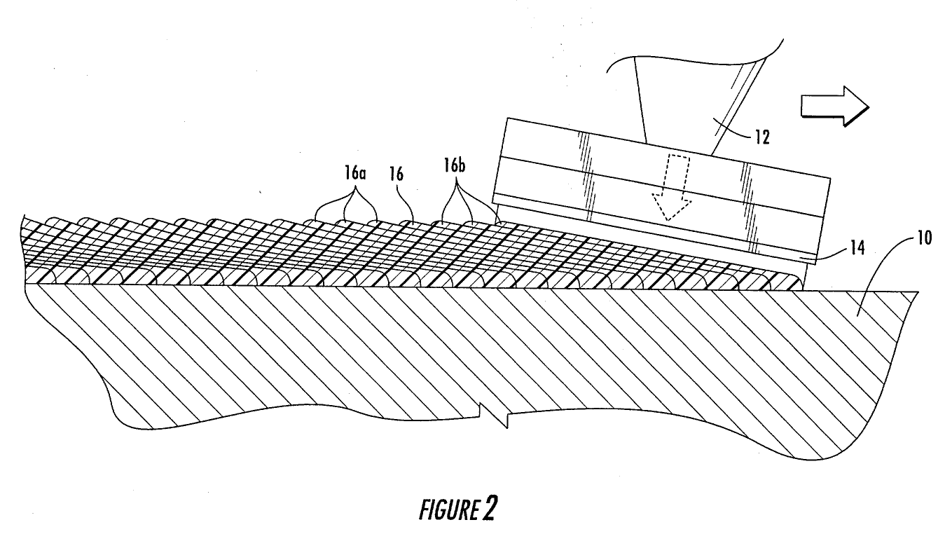

DETAILED DESCRIPTION OF EMBODIMENTS OF THE INVENTION

The present invention will now be described more fully hereinafter, in which preferred embodiments of the invention are shown. This invention may, however, be embodied in different forms and should not be construed as limited to the embodiments set forth herein. Rather, these embodiments are provided so that this disclosure will be thorough and complete, and will fully convey the scope of the invention to those skilled in the art. In the drawings, like numbers refer to like elements throughout, and thicknesses and dimensions of some components or features may be exaggerated for clarity.

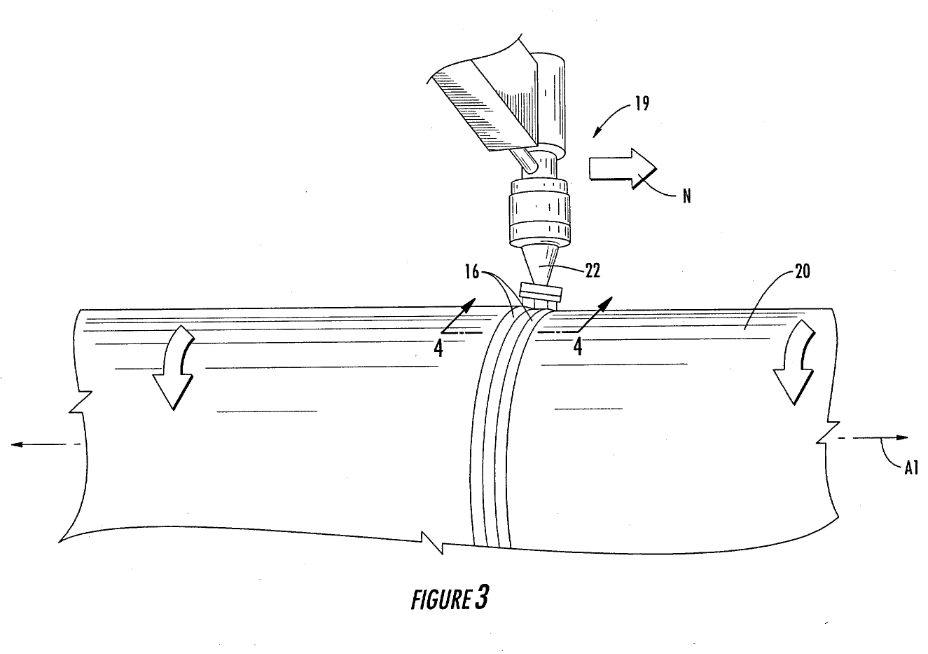

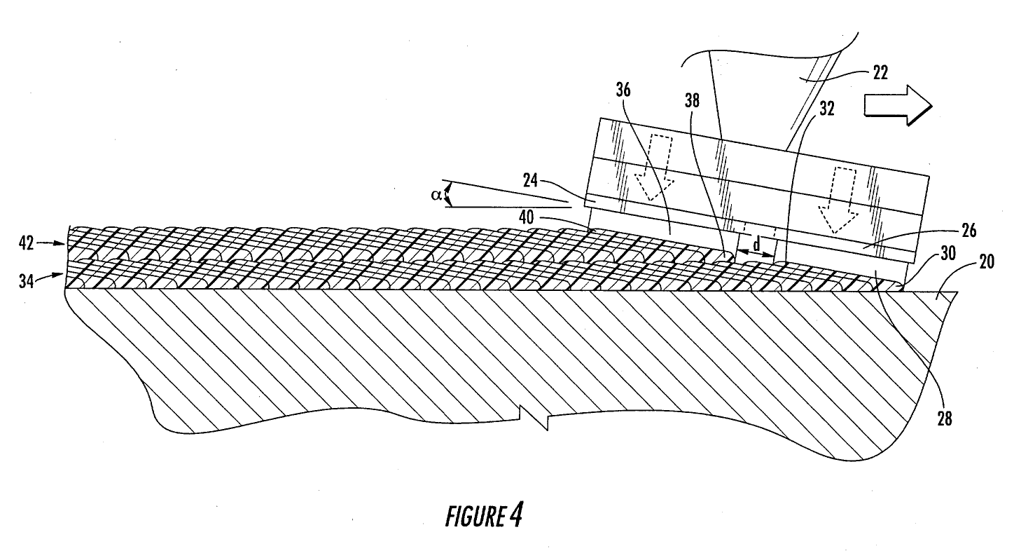

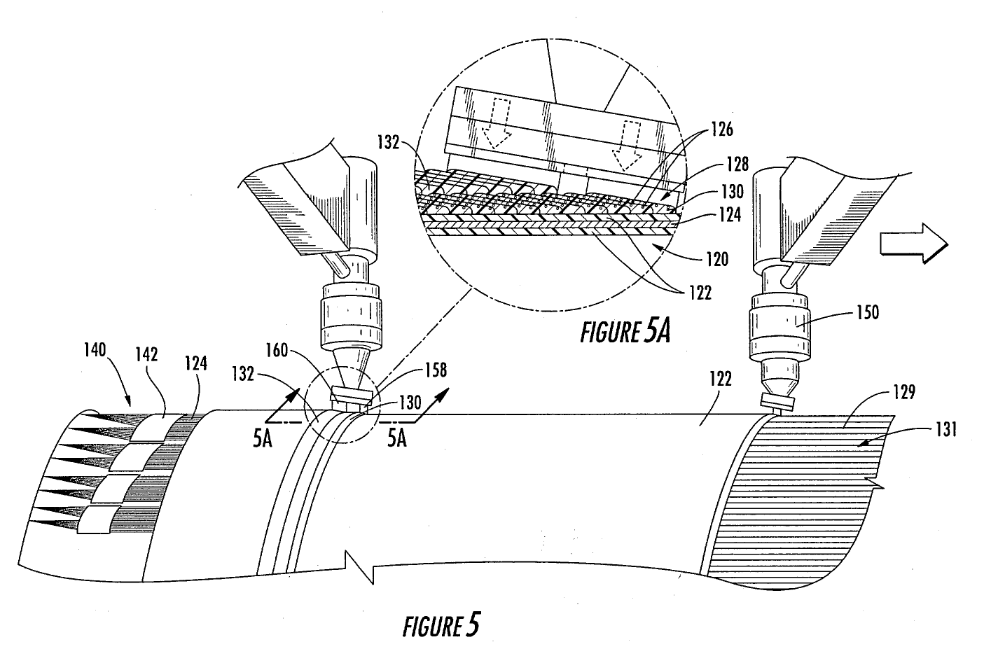

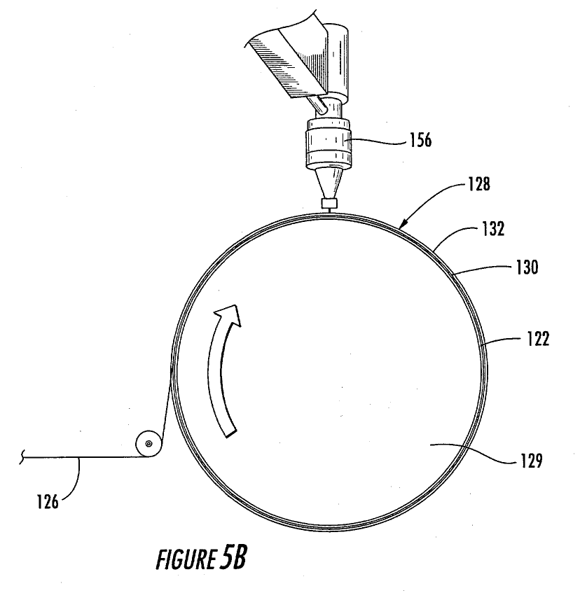

Referring now to the figures, a casting system, designated broadly at 19, is illustrated in FIGS. 3 and 4. The casting system 19 includes a core 20 and a multi-outlet nozzle 22. The core 20, which can comprise a mandrel by itself (the mandrel typically being formed of metal and optionally having its surface coated with a polymeric material) or a mandrel in conjunction with an overlying layer of polymeric material of a belt that underlies the layer to be added with the casting system 19 (as is described in connection with FIGS. 5, 5A and 5B), is elongate, substantially cylindrical and horizontally disposed, and is mounted on a fixture (not shown) that rotates the core 20 about its longitudinal axis Al. The configuration of the fixture that rotates the core 20 about the longitudinal axis Al can be any known to those skilled in this art for doing so and need not be described in detail herein; an exemplary fixture and mandrel are described in co-pending and co-assigned U.S. Provisional Patent Application No. 60/378,146 the disclosure of which is hereby incorporated herein in its entirety.

Referring again to FIGS. 3 and 4, the nozzle 22 is in fluid communication with a source of molten polymeric material (not shown) and is movable along a nozzle path N that is substantially parallel to and above the longitudinal axis Al. The configuration of the apparatus for translating the nozzle 22 along the path N can be any known to those skilled in this art for inducing such movement and need not be described in detail herein.

The nozzle 22 includes two separate outlets for polymeric material: an upstream outlet 24 and a downstream outlet 26 that is longitudinally offset from the upstream outlet 24. As used herein, the terms “upstream” and “downstream” refer to opposing directions that are parallel with the longitudinal axis Al and the nozzle path N, with the “downstream” direction referring to the direction that the nozzle 22 moves while dispensing polymeric material and the “upstream” direction referring to the direction opposite the “downstream” direction. The upstream outlet 24 continuously dispenses an upstream strip 36 of polymeric material, and the downstream outlet 26 continuously dispenses a downstream strip 28 of polymeric material. The upstream and downstream strips 36, 28 take the cross-sectional form of, respectively, the upstream and downstream outlets 24, 26, which are typically substantially rectangular and/or oblong.

As can be seen in FIG. 4, illustratively and preferably the upstream and downstream outlets 24, 26 are inclined relative to the nozzle path N at an angle α that is typically between about 1 and 13 degrees. Also, there is an offset distance d between the leading edge of the upstream outlet 24 and the downstream outlet 26 that is typically between about 0.5 and 7 inches, which distance is also approximately equal to the distance between the upstream and downstream strips 36, 28 during processing. The outlets 24, 26 may be configured to apply strips of polymeric material of similar width and thickness or of differing width and/or thickness; a thickness of between about 0.01 and 3 inches is typical.

In operation, as is illustrated in FIGS. 3 and 4, the core 20 is rotated about the longitudinal axis Al. The nozzle 22 begins at one end of the core 20. Polymeric material is applied to the core 20 as the upstream and downstream strips 36, 28 flow through the upstream and downstream nozzles 24, 26 simultaneously and continuously. As polymeric material is applied, the nozzle 22 translates slowly along the nozzle path N. The translation distance of the nozzle 22 during one revolution of the core 20 is less than the width of the upstream and downstream strips 36, 28, such that each of the upstream and downstream strips 36, 28 spirally winds onto the core 20 in overlapping fashion separated from each other by the offset distance d. In other words, as the core 20 rotates through an entire revolution, the portion of the downstream strip 28 being applied partially overlaps multiple preceding portions of the downstream strip 28, with the leading edge 30 of the downstream strip 28 contacting the core 20 and the lagging edge 32 being positioned downstream of the lagging edge of the previously applied portion of the downstream strip 28. Similarly, the portion of the upstream strip 36 being applied partially overlaps multiple preceding portions of the upstream strip 36, with the leading edge 38 of the upstream strip 36 contacting previously-applied portions of the downstream strip 28 and the lagging edge 40 being positioned downstream of the lagging edge of the previously applied portion of the upstream strip 28. The overlapping portions of the downstream strip 28 combine to form an inner layer 34, and the overlapping portions of the upstream strip 36 combine to form an outer layer 42.

The polymeric material being applied can be any known to those skilled in this art to be suitable for the production of belts; as examples, natural rubber; styrene-butadiene (SBR); nitrile rubber, chlorosulfonated polyethylene; EDPM; polyester; and polyurethane may be employed, with polyurethane being preferred. The polymeric material may contain additives and fillers that can modify or enhance its physical properties and manufacturing characteristics. Exemplary materials, additives and fillers are set forth in U.S. Pat. No. 4,224,372 to Romanski, U.S. Pat. No. 4,859,396 to Krenkel et al. and U.S. Pat. No. 4,978,428 to Cronin et al., the disclosures of each of which are hereby incorporated herein in their entireties. The polymeric material should be applied at a temperature that enables the material to flow from the nozzle 22 onto the core 20 and to bond thereto.

In some embodiments, one or more of the translation rate of the nozzle 22, the rotational speed of the core 20, and/or the offset distance d between the outlets 24, 26 are selected such that, as the downstream strip 28 is applied, portions of the downstream strip 28 underlying the portion of the downstream strip 28 being applied are sufficiently hardened so as to resist substantial sagging. Also, one or more of these parameters may be selected so that, as the upstream strip 36 is being applied over the downstream strip 28, portions of the downstream strip 28 underlying the portion of the upstream strip 36 being applied are sufficiently hardened so as to resist substantial sagging. Thus, the inner and outer layers 34, 42 formed from the upstream and downstream strips 36, 28 can maintain their shape during casting, with the result that an increased total thickness of the inner and outer layers 34, 42 can be achieved compared to the thickness of a layer applied with a single nozzle in a single pass.

Those skilled in this art will recognize that, although the use of the multi-outlet nozzle 22 is preferred, embodiments of the invention may be performed with two separate nozzles. If multiple nozzles are employed, the upstream and downstream strips they apply may be applied substantially simultaneously or not, but should be applied sufficiently proximate in time that the downstream strip is still molten and bondable to the upstream strip. It should also be apparent to those skilled in this art that more than two nozzles and/or nozzle outlets may be employed to apply more than two strips of polymeric material.

An additional embodiment of a shoe press belt, designated broadly at 120, is illustrated in FIGS. 5, 5A and 5B. The belt 120 includes a base layer 122, axially-extending reinforcing fibers 124, circumferentially extending reinforcing fibers 126, and a top stock layer 128 that comprises an inner layer 130 and an outer layer 132. In the illustrated embodiment, the base layer 122 completely encapsulates the axial fibers 124 (which are typically positioned about 0.025″-0.050″ above the bottom surface of the base layer 22) and extends about 0.020″ above the tops of the axial fibers 124. The circumferential fibers 126 are embedded in the top stock layer 128 (largely, if not entirely, in the inner layer 130 of the top stock layer 128). The top stock layer 128 covers and seals the circumferential fibers 126; also, the top stock layer 128 cross-links with the base layer 122 and provides adequate thickness (typically between about 0.1 and 3 inches) for further finishing operations. A typical belt 120 may be between about 40 and 80 inches in diameter, 50 and 400 inches in length, and 0.100 and 0.400 inches in thickness.

The reinforcing fibers 124, 126 may be formed of any suitable reinforcing material, but will ordinarily be formed of polyester, aramid, or other high performance fibers between about 0.008 and 0.050 inches in diameter. The fibers 124, 126 may be monofilament or multifilament strands. It is also contemplated that the fibers 124, 126 may take a flat, ribbonlike form, as this configuration may provide performance and manufacturing advantages.

Referring to FIGS. 5 and 5A, the belt 120 can be prepared in the following manner. After the preparation of a mandrel 129, the axial reinforcing fibers 124 are loaded onto the ends of the mandrel 129. In the illustrated embodiment, the axial fibers 124 are first formed into laminated multifiber bands 140, each of which includes a plurality of fibers 124 (for example, 70 at a time) strung in parallel relationship and laminated at each end with lamination sheets 142 or other sheet material. After the axial fibers 124 have been loaded onto the mandrel 129 and are positioned as desired, the base layer 122 is applied with a casting nozzle such as that designated at 150 in FIG. 5. The base layer 122 is preferably applied to a thickness that fully embeds the axial fibers 124 (a thickness that exceeds the top of the axial fibers 124 by about 0.020 inches is preferred). During application, the nozzle 150 begins at one end of the mandrel 129 and moves axially on a track (not shown) as the mandrel 129 rotates about its axis; in this manner, the working surface 131 of the mandrel 129 becomes coated with the base layer 122.

Referring still to FIGS. 5, 5A and 5B, the top stock layer 128 and the circumferential fibers 126 are applied after application of the base layer 122 (preferably while the base layer 122 is still semi-soft). Individual creels of fibers (not shown) area stationarily mounted or are mounted on a cart (also not shown) that is attached to and moves axially in concert with a multi-outlet nozzle 156 that applies the top stock layer 128. The nozzle 156 applies the inner layer 130 of the top stock layer 128 through an outlet 158 (typically at a thickness of between about 0.01 and 0.15 inches), and simultaneously, through an outlet 160, applies the outer layer 132 of the top stock layer 128 upstream of the portion of the inner layer 130 that is being applied (typically at a thickness of between about 0.1 and 0.3 inches). Thus, as illustrated in FIG. 5A, several revolutions of the mandrel 129 occur before the outer layer 132 is applied over the inner layer 130 at a given axial location. The circumferential fibers 126 are applied over the inner layer 130 (and, in the illustrated embodiment, become embedded in the inner layer 130 due to tension applied to the circumferential fibers 126) once the mandrel 129 has rotated 270 degrees from the application point of the inner layer 130. A set of as many as six or more circumferential fibers 126 may be wound into the inner layer 130 at once. Several mandrel revolutions after the application of the circumferential fibers 126, the outer layer 132 is then applied over the inner layer 130 and any exposed circumferential fibers 126.

The process as described can achieve many of the performance advantages described above. In addition, the introduction of the circumferential fibers 126 into the top stock layer 128 after the application of the inner layer 130 but before the application of the outer layer 132 can help to prevent the entrainment of air in the top stock layer 128. Other aspects of this general process of belt production are described in the aforementioned co-pending and co-assigned U.S. Provisional Patent Application No. 60/378,146.

The foregoing is illustrative of the present invention and is not to be construed as limiting thereof. Although exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. The invention is defined by the following claims, with equivalents of the claims to be included therein.

That which is claimed is:

1. A process for forming an endless belt for a press, comprising the steps of:
providing an elongate cylindrical core having a longitudinal axis;
rotating the core about the longitudinal axis;
providing a nozzle movable along a nozzle path that is substantially parallel to and above the core longitudinal axis, the nozzle having at least an upstream outlet and a downstream outlet, the nozzle outlets being longitudinally offset a distance from each other; and
applying multiple strips of polymeric material to the core through the nozzle outlets as the nozzle moves along the nozzle path such that the downstream strip forms an overlapping spiral inner layer and the upstream strip forms an overlapping spiral outer layer that overlies the inner layer.

2. The process defined in claim 1, wherein each of the upstream strip and the downstream strip includes leading and lagging edges, and wherein the lagging edge of the downstream strip is positioned downstream of the leading edge of the upstream strip during the applying step.

3. The process defined in claim 2, wherein at least one of the polymeric material, the temperature of the polymeric material, the rotational speed of the core, and the offset distance of the nozzle outlets is selected such that, as the downstream strip is applied, previously-applied portions of the downstream strip underlying a portion of the downstream strip being applied are sufficiently hardened so as to resist substantial sagging.

4. The process defined in claim 3, wherein the at least one of the polymeric material, the temperature of the polymeric material, the rotational speed of the core, and the offset distance of the nozzle outlets is selected such that, as the upstream strip is applied, portions of the inner layer underlying a portion of the upstream strip being applied are sufficiently hardened so as to resist substantial sagging.

5. The process defined in claim 1, wherein the polymeric material is selected from the group consisting of: natural rubber; SBR; nitrile rubber, chlorosulfonated polyethylene; EDPM; and polyurethane.

6. The process defined in claim 1, wherein the thickness of the upstream strip is between about 0.1 and 0.3 inches.

7. The process defined in claim 1, wherein the thickness of the downstream strip is between about 0.01 and 0.15 inches.

8. The process defined in claim 7, wherein the thickness of the upstream strip is between about 0.1 and 0.3 inches.

9. The process defined in claim 2, wherein the leading edge of the downstream strip is positioned between about 0.5 and 7 inches from the lagging edge of the upstream strip as each are being applied.

10. The process defined in claim 1, wherein the core comprises a mandrel covered with a polymeric base layer for the endless belt, the base layer bonding with the inner layer and being removable from the mandrel.

11. The process defined in claim 1, further comprising the step of applying circumferential reinforcing fibers over the inner layer.

12. The process defined in claim 1, wherein the circumferential reinforcing fibers are applied over a portion of the downstream strip prior to the application of a portion of the upstream strip that overlies that portion of the downstream strip.

13. The process defined in claim 12, wherein the circumferential reinforcing fibers are spirally wound over the inner layer at a tension sufficient to embed the reinforcing fibers in the inner layer.

14. A process for forming a belt for a press, comprising the steps of:
providing an elongate cylindrical core having a longitudinal axis;
rotating the core about the longitudinal axis;
applying a downstream strip of a polymeric material to the core such that the downstream strip forms an overlapping spiral inner layer; and then
applying an upstream strip of the polymeric material over the inner layer such that the upstream strip forms an overlapping spiral outer layer that overlies the inner layer;
wherein the upstream strip is applied sufficiently proximate in time to the application of the downstream strip that the downstream strip is molten and bondable to the upstream strip, but sufficiently distant in time that the downstream strip has sufficiently hardened to avoid substantial sagging.

15. The process defined in claim 14, wherein the steps of applying the upstream and downstream strips are performed substantially simultaneously at different axial locations on the core.

16. The process defined in claim 15, wherein the steps of applying the upstream and downstream strips are performed with a single application nozzle having upstream and downstream nozzle outlets.

17. The process defined in claim 14, wherein the polymeric material is selected from the group consisting of: natural rubber; SBR; nitrile rubber, chlorosulfonated polyethylene; EDPM; and polyurethane.

18. The process defined in claim 14, wherein the thickness of the upstream strip is between about 0.01 and 0.15 inches.

19. The process defined in claim 14, wherein the thickness of the downstream strip is between about 0.1 and 0.3 inches.

20. The process defined in claim 14, wherein the core comprises a mandrel covered with a polymeric base layer for the endless belt, the base layer bonding with the inner layer and being removable from the mandrel.

21. The process defined in claim 14, further comprising the step of applying circumferential reinforcing fibers over the inner layer.

22. The process defined in claim 21, wherein the circumferential reinforcing fibers are applied over a portion of the downstream strip prior to the application of a portion of the upstream strip that overlies that portion of the downstream strip.

23. The process defined in claim 22, wherein the circumferential reinforcing fibers are spirally wound over the inner layer at a tension sufficient to embed the reinforcing fibers in the inner layer.

24. An endless belt for use in a shoe press, comprising:
a substantially cylindrical inner layer, the inner layer being formed of a spirally wound, overlapping strip of a first polymeric material; and
a substantially cylindrical outer layer that circumferentially overlies the inner layer, the outer layer being formed of a spirally wound, overlapping strip of the first polymeric material.

25. The endless belt defined in claim 24, further comprising circumferential reinforcing fibers embedded in the inner layer.

26. The endless belt defined in claim 25, further comprising a substantially cylindrical base layer that circumferentially underlies the inner layer, the base layer being formed of a second polymeric material.

27. The endless belt defined in claim 24, wherein the polymeric material is selected from the group consisting of: natural rubber; SBR; nitrile rubber, chlorosulfonated polyethylene; EDPM; and polyurethane.

28. The endless belt defined in claim 24, wherein the thickness of the upstream strip is between about 0.01 and 0.15 inches.

29. The endless belt defined in claim 24, wherein the thickness of the downstream strip is between about 0.1 and 0.3 inches.
